(19) United States
(12) Patent Application Publication
(10) Pub. No.: US 2017/0287347 A1
(43) Pub. Date: Oct. 5, 2017

(54) MULTI-SCREEN CASTING SYSTEM FOR FLIPPED TEACHING CLASSROOM

(71) Applicant: Teh-Chau Liau, Hsinchu County (TW)

(72) Inventors: Teh-Chau Liau, Hsinchu County (TW); Jian Qi Shen, Hangzhou (CN); Shun-Feng Su, Taipei (TW)

(21) Appl. No.: 15/088,129

(22) Filed: Apr. 1, 2016

(51) Int. Cl. G09B 5/12; G09B 5/06; H04N 21/41; H04N 21/63; H04N 21/4363; H04N 21/414

(52) U.S. Cl. CPC G09B 5/125; H04N 21/43637; H04N 21/43635; H04N 21/41415; H04N 21/4122; H04N 21/632; G09B 5/067

(57) ABSTRACT

The multi-screen casting system for a flipped teaching classroom contains, with the classroom, at least a receiving screen having a video/audio receiving interface connected to a multimedia streaming device, a set of at least two inter-casting devices, and a wireless broad band base station providing dual-band (2.4 GHz and 5.0 GHz) WiFi LAN communications. The multimedia streaming device contains firmware for locating and processing video/audio transmission within the WiFi LAN, and presenting received video/audio or data on the connected receiving screen. Each inter-casting device is one of a notebook computer, a smart phone, and a tablet computer. The inter-casting devices conduct, in a time-sharing manner, peer-to-peer communications among themselves and many-to-one communications to the multimedia steaming device of the receiving screen.

### BACKGROUND OF THE INVENTION

### (a) Technical Field of the Invention

The present invention is generally related to a multi-screen casting system for flipped teaching classroom, and more particular to a multi-screen casting system allowing multiple participants to exchange message through WiFi local area network within a classroom so as to facilitate group learning and discussion.

### (b) Description of the Prior Art

Conventional teaching involves a speaker (a teacher or a presenter) delivering knowledge to a number of listeners (students or audience). Even though some tools such as computer or projector systems are utilized, the teaching and learning effect is limited as only one-way communication is provided. If a student has a question, he or she has to raise the question so as to two-way communicate with the teacher. Often times, this kind of interaction is rather inconvenient.

What is shown in FIG. 7 is a common scenario in a school's classroom. The teacher 60 uses a computer 62 on a desk 61 and the content of the computer 62 is projected to a big screen 64 through a projector 63. A number of students 70 watch and learn from the big screen 64 simultaneously. When a student 70 has a question, he or she has to ask the teacher 60 for help. However, due to limited space and time, the teacher 60 can only observe a few students 70's operation in their computers 80. For the teacher 60, bending down to observe the computer 80 is also quite uncomfortable and time consuming When multiple students 70 have a same question, the teacher 60 has to answer them one by one. For different questions, the teacher 60 still has to answer them one by one. Many times good teaching examples cannot achieve the desired effect. It is difficult to lead a group discussion over a single question. It is always a one-on-one mode between the teacher 60 and the students 70, thereby wasting a lot of time and delaying the progress. The teacher 60 always runs around in the classroom, which is a big challenge for both the teacher 60 and the students 70 alike.

Additionally, as shown in FIG. 2, a group of students are often arranged in an array in front of a big screen. The perception of the video and audio effect from the big screen would be very different between students in the front rows and those in the back rows. The visual clarity is inverse proportional to the distance to the screen. The students' comprehension would decrease as well. Chances of interaction diminishes And the learning effect is unsatisfactory.

As shown in FIG. 6, even though the students are arranged in an arc in a close distance to a screen, it is still not possible to provide the best front view to every student. The speaker still cannot deliver his/her thought fully to everyone present, again compromising the interaction and learning effect.

Currently there are interaction-based teaching software applications. However they are all for children who achieve learning through visual and audio effects. But multiple-participant interaction-based teaching system (e.g., for flipped teaching classroom) providing official, role exchange in real time, and mutual computer control through mice is yet to be developed.

### SUMMARY OF THE INVENTION

A major objective of the present invention is to provide an interaction-based platform for flipped teaching classroom where a teacher and multiple students can exchange and present messages immediately through an independent wireless broad band network, so that teaching time can be reduced, the teacher can better understand the students' thoughts, mutual stimulation among students can be achieved, and learning interest is enhanced.

Another major objective of the present invention is that, by equipping software applications in a set of notebook computers, smart phones, and tablet computers that are compatible with multimedia steaming devices within the wireless coverage of a dual-band (2.4 GHz and 5.0 GHz) wireless broad band base station, messages are delivered from these computers to a first receiving screen and a second receiving screen in a time-sharing peer-to-peer or many-to-one manner. These computers can also mutually exchange messages also in a time-sharing peer-to-peer or many-to-one manner, thereby achieving seam less message communications and a significantly more lively teaching style where students brain-storm together, and learn together.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a multi-screen casting system according to the present invention.

FIG. 2 is a schematic diagram showing an application environment of the multi-screen casting system of FIG. 1.

FIG. 3 is a perspective diagram showing the connection of a multimedia streaming device to a receiving screen of the multi-screen casting system of FIG. 1.

FIG. 4 is a schematic diagram showing an operation scenario of the multi-screen casting system of FIG. 1.

FIG. 5 is a schematic diagram showing another operation scenario of the multi-screen casting system of FIG. 1.

FIG. 6 is a schematic diagram showing a teaching scenario in a conventional classroom. FIG. 7 is a schematic diagram showing another teaching scenario in a conventional classroom.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

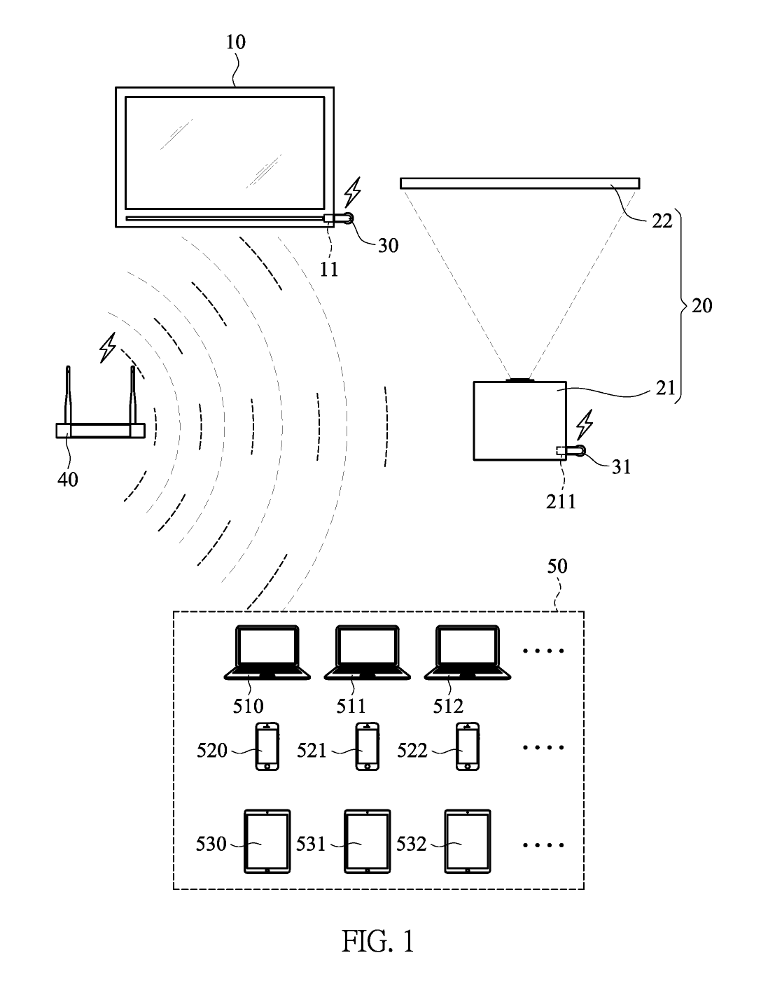

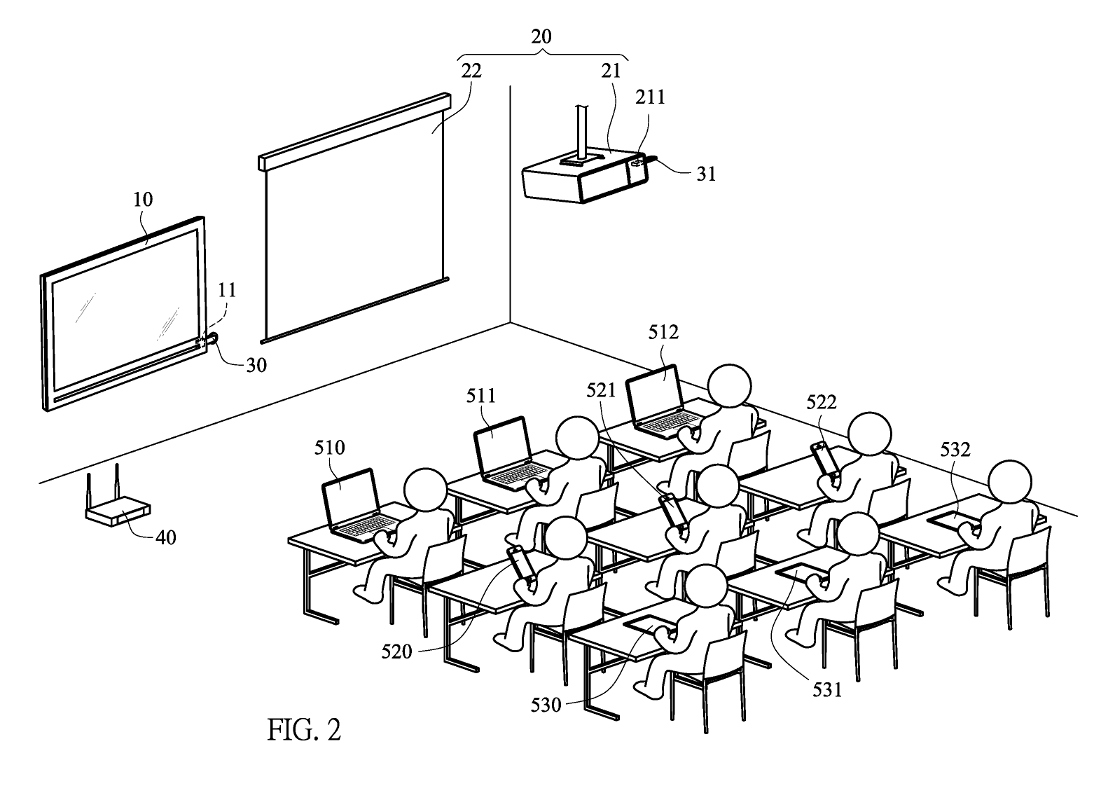

As shown in FIGS. 1 and 2, a multi-screen casting system according to an embodiment of the present invention contains, within a classroom, at least the following components.

A first receiving screen 10 is a self-illuminating-type display device having a first video/audio receiving interface 11. A second receiving screen 20 is a reflection-type display device have a second video/audio receiving interface 211. In the present embodiment, the first and second video/audio receiving interfaces 11 and 211 are High Definition Multimedia Interface (HDMI) connectors. The first receiving screen 10 is a HDMI interfaced television set, and the second receiving screen 20 is a projector set, including a HDMI interfaced projector 21 and a projector screen 22.

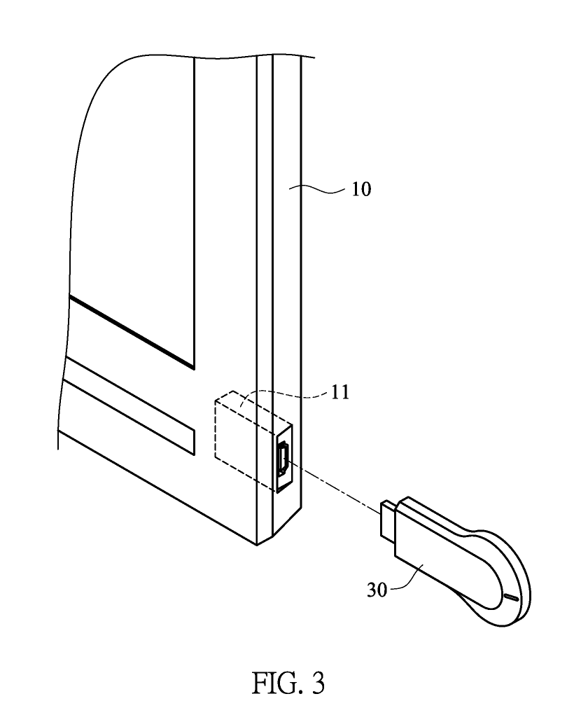

Two multimedia steaming devices 30 and 31 are hardware devices equipped with firmware for locating and processing peer-to-peer video/audio transmission within a WiFi local area network (LAN). The multimedia steaming devices 30 and 31 are connected to the first and second video/audio receiving interfaces 11 and 211, respectively, as shown in FIG. 3 so that received video/audio or data signal is directly displayed on the first and second receiving screens 10 and 20, respectively.

There is a set of at least two inter-casting devices 50. Each inter-casting device 50 can be a notebook computer 510, a smart phone 520, a tablet computer 530, or a similar processing device.

A wireless broad band base station 40 provides dual band (2.4 GHz and 5.0 GHz) wireless communications so that the multimedia steaming devices 30 and 31, and the notebook computers 510, smart phones 520, tablet computers 530 of the set of inter-casting devices 50 can, in a time-sharing manner, conduct peer-to-peer communications and many-to-one communications to the receiving screens 10 and 20.

The notebook computers 510, smart phones 520, tablet computers 530 of the set of inter-casting devices 50 are all equipped with software applications compatible with the wireless broad band base station 40, and the multimedia steaming devices 30 and 31. As such, these inter-casting devices 50 conduct peer-to-peer communications among themselves and conduct many-to-one communications to the multimedia steaming devices 30 and 31 of the first and second receiving screens 10 and 20 through the wireless broad band base station 40 in a time-sharing manner. What is received by the multimedia steaming devices 30 and 31 is immediately presented on the first and second receiving screens 10 and 20, respectively.

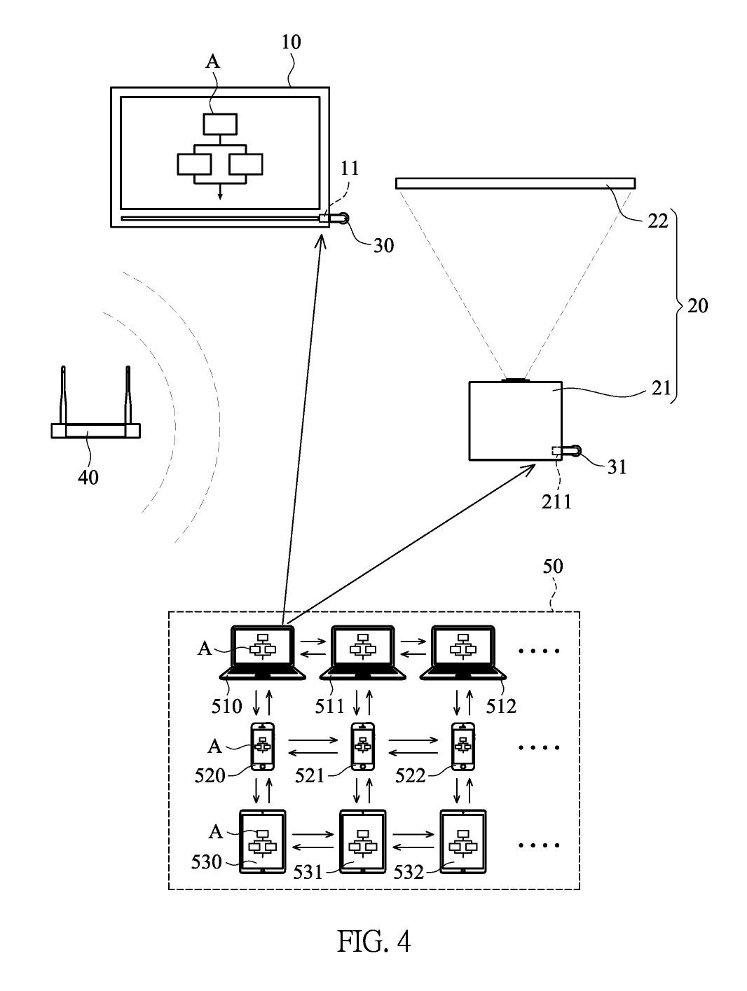

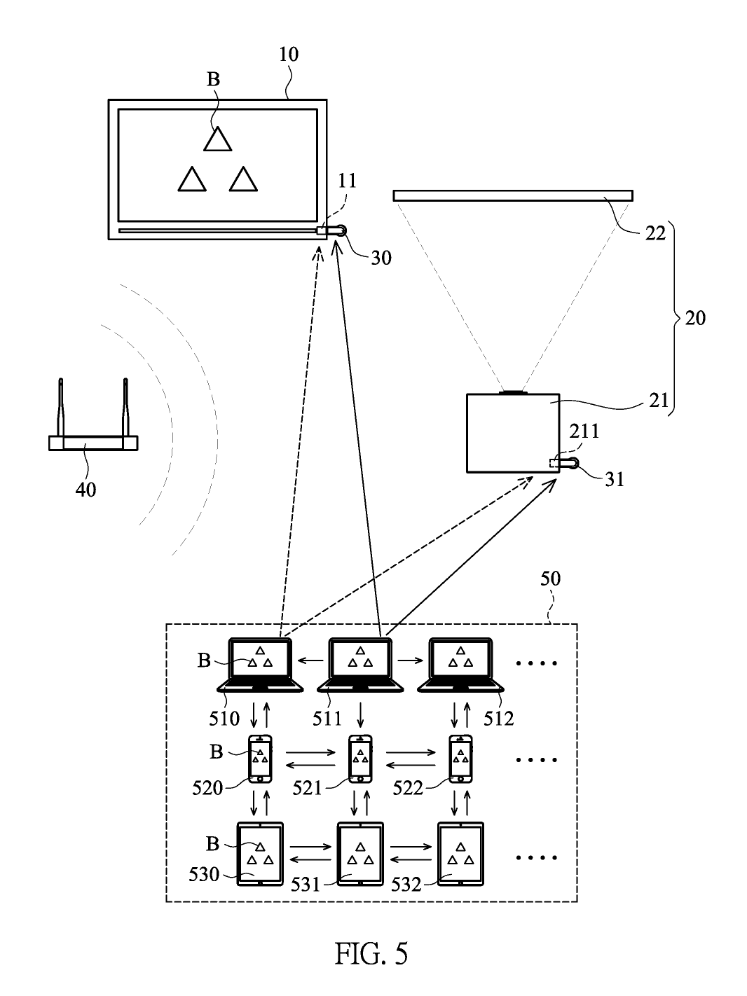

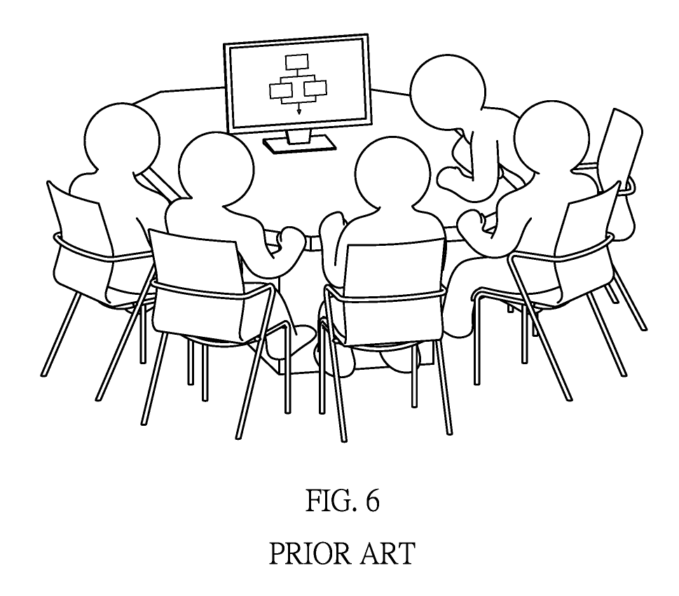

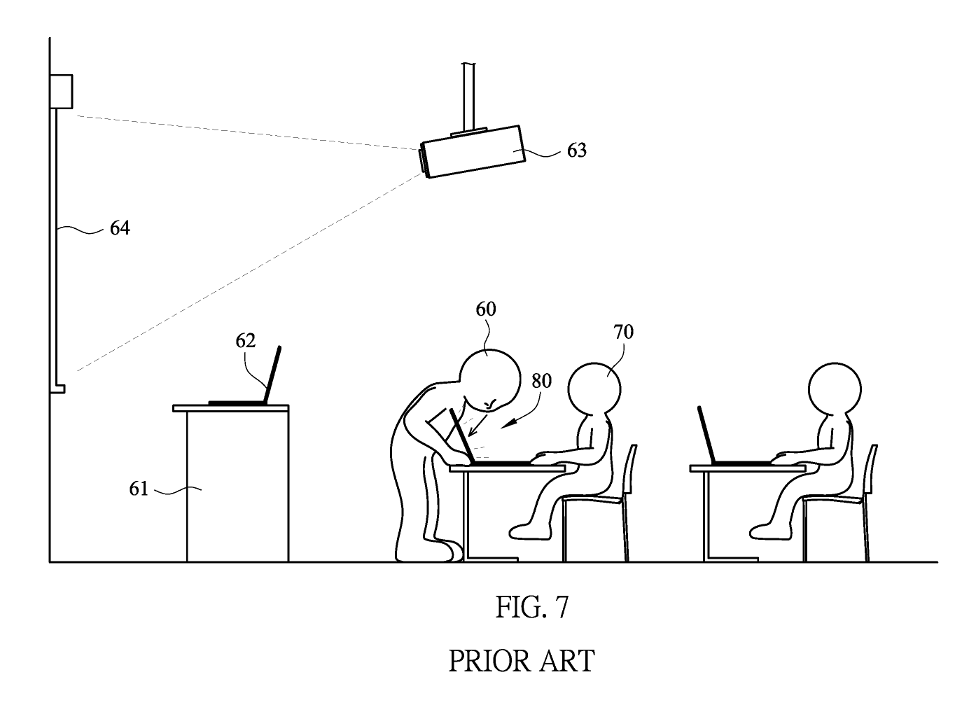

As shown in FIG. 4, when a student raises a question from a notebook computer 510 of the set of inter-casting device 50, a related message A of the notebook computer 510 is delivered to and presented on the first receiving screen 10, the second receiving screen 20, and other notebook computers 511, 512, smart phones 520, 521, 522, table computers 530, 531, 532 within the set of inter-casting devices 50 so that everyone in the classroom can receive the message A. As shown in FIG. 5, if another student responds the question or raises another question from a notebook computer 511 of the set of inter-casting device 50, a related message B of the notebook computer 511 is delivered to and presented on the first receiving screen 10, the second receiving screen 20, and other notebook computers 510, 512, smart phones 520, 521, 522, table computers 530, 531, 532 within the set of inter-casting devices 50, overwriting the earlier message A, so that everyone in the classroom can receive the message B and continue discussion, thereby achieving interactive message communications.

The present invention provides a clear and speedy mutual communication platform for problem solving among the teacher and the students. This platform also allows multiple other students to communicate among themselves to help each other in comprehension of the question. This kind of interaction-based teaching can further stimulate students' interest. The teacher on the other hand can clearly understand the students' thoughts and difficulties. As such, not only learning effect is enhanced and the teacher's effort is reduced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A multi-screen casting system for a plurality of students and at least a teacher within a flipped teaching classroom, comprising, within the classroom,
a first receiving screen having a first video/audio/data receiving interface (HDMI, High-Definition Multimedia Interface), where the first receiving screen is a self-illuminating display device;
a second receiving screen having a second video/audio/data receiving interface (HDMI, High-Definition Multimedia Interface), where the second receiving screen is a reflection-type display device;
a first multimedia streaming device which is controlled by the top-governed teacher and wiredly or wirelessly connected to the first and second video/audio/data receiving interfaces (displaying identical contents), respectively;
a second multimedia streaming device which is comprised in the inter-casting devices and wirelessly connected to the first and second video/audio/data receiving interfaces (displaying identical contents), respectively;
a plurality of inter-casting devices, one for each student and the temporally moderated teacher, where each inter-casting device is one of a notebook computer/smart phone/tablet computer and can be the one of second multimedia streaming device on demand; and
a wireless broad band base station providing a dual-band (2.4 GHz and 5.0 GHz) WiFi local area network (LAN);
wherein each of the inter-casting devices conducts a peer-to-peer transmission of video/audio/data with another inter-casing device or with one of the first and second multimedia streaming devices over the WiFi LAN;
each of the inter-casting devices conducts a peer to multi-peer (i.e., one-to-many) transmission of video/audio/data with the first and second multimedia streaming devices and at least another one inter-casing device over the WiFi LAN;
the first and second multimedia streaming devices may assign the video/audio/data material to be displayed on the first and second receiving screens;
the peer-to-peer and peer-to-multi-peer (i.e., one-to-many) transmissions of video/audio/data occur in a time-sharing manner and shunt-distributed-channel allocation among the inter-casting device over the WiFi LAN; and
the first and second receiving screens are always visible to all inter-casting devices (i.e., the students and the top-governed/temporally-moderated teacher).

2. The multi-screen casting system according to claim 1, wherein the first receiving screen is a High Definition Multimedia Interface (HDMI) interfaced television set.

3.The multi-screen casting system according to claim 1, wherein the second receiving screen is a projector set, including a HDMI interfaced projector and a projector screen.

4-6. (canceled)
